(19) United States
(12) Patent Application Publication
(10) Pub. No.: US 2008/0266686 A1
(43) Pub. Date: Oct. 30, 2008

(54) Facet mirror comprising a multiplicity of mirror segments

(75) Inventor: Guenther Dengel, Heidenheim (DE)

Correspondence Address: WELLS ST. JOHN P.S., 601 W. FIRST AVENUE, SUITE 1300, SPOKANE, WA, 99201, US

(73) Assignee: Carl Zeiss SMT AG

(21) Appl. No.: 11/789,072

(22) Filed: Apr. 23, 2007

Related U.S. Application Data
(60) Provisional application No. 60/794,759, filed on Apr. 24, 2006.

(30) Foreign Application Priority Data
Jul. 8, 2006 (DE) 10 2006031 654.1

(51) Int. Cl. G02B 5/09

(52) U.S. Cl. 359/851

(57) ABSTRACT

A facet mirror is provided with a multiplicity of mirror segments (11) which have reflective surfaces (13). A number of mirror segments (11) are in each case arranged on a mirror carrier (9). At least a part of the mirror segments (11) has an aspect ratio of greater than 1:5, is identically arranged and accommodated individually in a holder (10).

This application claims the benefit under 35 U.S.C. 119(e) (1) of U.S. Provisional Application No. 60/794,759 filed Apr. 24, 2006 and of German Patent Application No. 10 2006 031 654.1 filed Jul. 8, 2006.

### BACKGROUND OF THE INVENTION

1. Field of the Invention

The invention relates to a facet mirror comprising a multiplicity of mirror segments which are provided with reflective surfaces, a number of mirror elements in each case being arranged on a mirror carrier.

The invention also relates to a projection exposure system in EUV lithography, comprising at least one facet mirror.

2. Description of the Related Art

A facet mirror of the type initially mentioned is described, for example, in DE 100 30 495 A1. Such facet mirrors are used in, among other things, an illumination system of a projection exposure system for EUV lithography for producing semiconductor elements. In this context, the light of a light source, for example of a laser, is directed to one or more facet mirrors so that a desired uniform illumination of a reticule (mask) can be achieved. From the reticule, the pattern of the reticule is then directed to a wafer for imaging via a subsequent projection lens.

Due to the high precision required with respect to homogeneous illumination and imaging on the wafer, the production of the facet mirrors, which consist of a multiplicity of mirror elements, is very complex. The mirror segments with their reflective surfaces must be arranged for this purpose in each case individually with different tilt angles, generally in two planes and then mounted correspondingly on a mirror carrier. For this purpose, the mirror elements are in each case produced individually which represents correspondingly great effort and costs.

In WO 03/050586 and in WO 03/067288 A1, a facet mirror is described in each case, the mirror facets or mirror segments in each case being arranged individually on a mirror carrier via an intermediate element.

In WO 2005/006081 A1, a facet mirror comprising a multiplicity of directly adjacently arranged mirror segments is known from FIGS. 12 and 13, the mirror segments being arranged individually directly on a mirror carrier for which purpose they must have a corresponding shape and relatively large thickness.

With respect to the general prior art, reference is also made to EP 0 916 984 A1 and WO 03/067304 A1.

### SUMMARY OF THE INVENTION

The present invention is, therefore, based on the object of creating a facet mirror of the type initially mentioned which, even though it maintains the required high precision, is arranged in such a manner that it can be produced and mounted with less effort with respect to position and arrangement of the mirror segments on the mirror carrier.

According to the invention, this object is achieved by the features mentioned in the characterizing clause of Claim 1.

Instead of a predefined arrangement of the mirror segments on the mirror carrier or of the connection of the mirror segments to the mirror carrier in accordance with the individual arrangement of the mirror segments with their reflective surfaces, the identical mirror elements, according to the invention, are now accommodated in a holder in such a manner that the identical mirror elements are correspondingly in each case individually arranged and aligned.

In this arrangement, the mirror segments can also be advantageously arranged in predetermined different tilt angles.

Although mounting with in each case different tilt angles in correspondingly different receptacles in the holder also represents a greater effort, this effort is less compared with an arrangement of the mirror elements with in each case individually formed tilt angles which are generally provided in two planes. The reason for this is also, in particular, that the material and the machining of the mirror segments with their reflective surfaces is more complex and expensive.

The aspect ratio of greater than 1:5, preferably greater than 1:20, is of particular advantage particularly for facet mirrors in an embodiment as field facet mirrors. In the case of a rectangular embodiment of a mirror segment or of a mirror facet, aspect ratio is understood to be the ratio of the sides of a rectangle which, in the present case, means that very narrow rectangles are formed. If the mirror facet has a curved form projected onto the mirror carrier, the aspect ratio can be defined as the ratio between the length of a maximum arc line and the maximum width perpendicularly to the arc line of the curved form.

A field facet mirror disperses the parallel or convergent light beam coming from a light source and an upstream collector lens and creates secondary light sources at the location of a pupil facet mirror. Unlike a pupil facet mirror which is preferably round or slightly elliptical and does not need to be illuminated completely, a field facet mirror requires an area to be completely illuminated there by the upstream collector. The illuminated area should have at least approximately a form of a field which results in a correspondingly high aspect ratio. In the subsequent reticule plane preceding a projection lens, the field can have a size of 100×8 mm, for example.

To achieve this complete illumination, the mirror segments must therefore be arranged correspondingly as closely as possible and without intermediate spaces, if possible, next to one another. Unlike a pupil facet mirror in which there is correspondingly more space, this means that the accommodation of a tilting device for in each case individually tilting mirror segments is very problematic and complex.

Due to the solution according to the invention comprising the mirror segments which are now arranged identically according to the invention, a distinct improvement in the production of facet mirrors is achieved. This particularly applies with regard to cost and effort. Since, according to the invention, the individual mirror segments are now arranged to be identical, they can be produced in series production with one tool. Since the requirements for extremely small surface roughness of the reflective surfaces of the mirror segments are very high, the polishing required for this represents a very large challenge. Such surface polishing can generally only be produced with very few materials such as, for example, silicon. However, the respective individual surface processing for, for example, 300 mirror segments which are different with respect to radius and tilt angle and should only have a tolerance of 0.5 millirad, would be extremely expensive within this specification.

According to the invention, such individual surface processing with regard to the radius and tilt angle required in each case can now be omitted since the exact arrangement of radius and tilt angle of each mirror segment is now transferred into the holder according to the invention.

If the mirror segments are arranged to be correspondingly thin so that they can be easily bent, they can be accommodated in each case with the corresponding predetermined radius in the associated holder. In this case, only the respective tilt angles of the mirror segments then need to be adjusted by correspondingly supporting the mirror segments in the holder.

One or more holders with the mirror segments arranged according to the invention can then be connected with the mirror carrier or mounted on it in any manner.

Due to the aforementioned receptacles in the holder, the expenditure for producing a facet mirror can thus be considerably reduced because, if necessary, all mirror segments can be arranged identically in this manner. The required individual adjustment of tilt angles for generating a homogeneous illumination is achieved by means of the receptacle in the holder according to the invention.

Due to this identical embodiment, the mirror segments can be advantageously formed in each case, for example, from strips which are in each case provided with a reflective surface on one longitudinal side.

The strips can advantageously have at least approximately a saw blade shape, the protruding parts of the strips being arranged as receptacles for the mirror segments.

In a further embodiment of the invention, the strips can be separated out of a disc or plate.

A silicon body can be used as disc or plate. In particular, a wafer disc is also suitable for this purpose which thus forms a very cost-effective use for this new application. The connection or mounting of the mirror segments on the holder can be effected via correspondingly arranged receptacles, taking into consideration in each case the predetermined tilt angle.

The mirror segments can be connected to the holder, in its receptacles, in different ways, for example by means of a non-positive, positive or surface-bonded connection. For non-positive connections, clamp or snap-on connections can be provided, for example. Surface-bonded connections such as, for example, joining techniques such as bonding, solder or metallic connections are also very suitable.

Further advantageous embodiments and developments can be obtained from the remaining subclaims and from the illustrative embodiments shown in principle in the text which follows by means of the drawings.

### BRIEF DESCRIPTION OF THE DRAWINGS

FIG. 1 shows a basic representation of a projection exposure system with an EUV illumination system and a projection lens with facet mirrors according to the invention;

FIG. 2 shows a perspective representation of a facet mirror according to the invention;

FIG. 3 shows a side view (in section) of a holder with mirror segments;

FIG. 4 shows a facet mirror with curved mirror segments;

FIG. 5 shows a top view of a silicon disc;

FIG. 6 shows an enlarged representation of a mirror segment;

FIG. 7 shows a top view of a substrate carrier moulded by electrodeposition;

FIG. 8 shows a greatly enlarged section through a holder with a mirror segment, arranged on a mirror carrier; and

FIG. 9 shows an enlarged perspective representation of a part of a holder with a mirror segment.

### DETAILED DESCRIPTION

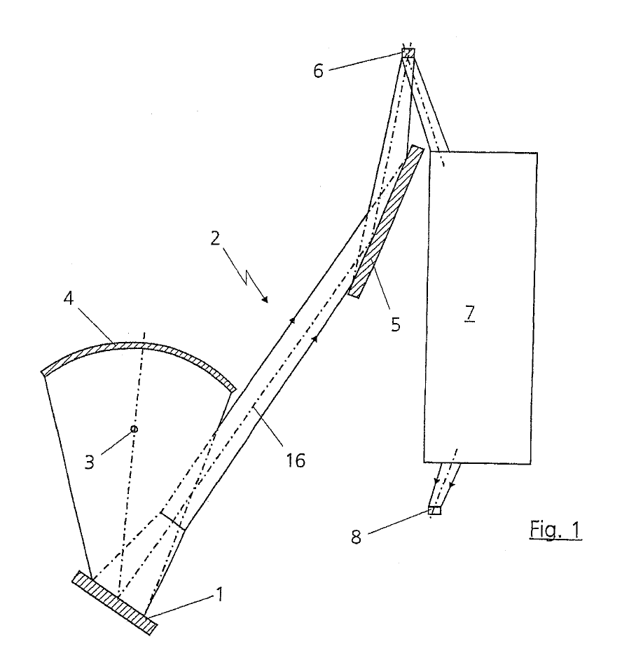

FIG. 1 shows, for example, a facet mirror 1 in a projection exposure system with an illumination system 2. The light of a light source 3, for example of a laser, is deflected via a collector mirror 4 to the facet mirror 1 which forms a field facet mirror, from where it is supplied to a reticule 6 with a desired uniform illumination via a deflection mirror 5. The pattern of the reticule 6 is conducted via a projection lens 7, not shown in greater detail, with optical elements, to a wafer 8 for the greatly reduced imaging of the image of the reticule 6.

The light bundle produced by the field facet mirror 1 is imaged on the reticule 6 with the aid of further mirrors such as, for example, pupil facet mirrors (not shown) as secondary light sources in the entry pupil of the projection lens 7.

In principle, this type of illumination guidance is generally known which is why it is not discussed in greater detail here. Reference is made in this context to U.S. Pat. No. 6,658,084 B2 and U.S. Pat. No. 6,438,199 B1 in which such a projection exposure system with an EUV illumination system is described in detail. These two documents thus also form a disclosure content for the present application.

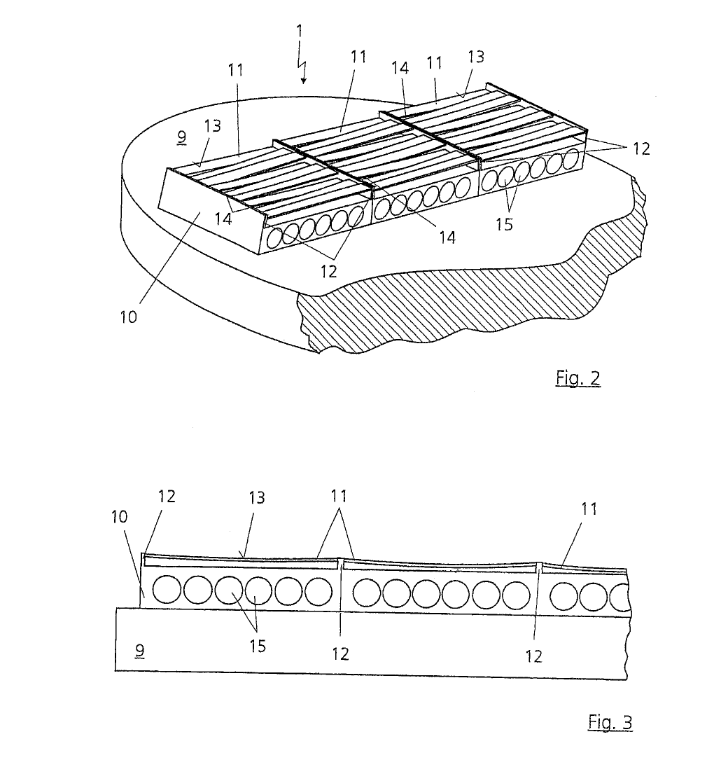

FIG. 2 shows the structure of the facet mirror 1 in enlarged perspective representation. The facet mirror 1 has a mirror carrier 9 on which one or more holders 10 are arbitrarily mounted such as, for example, by screwing, soldering, bonding or the like. Each holder 10 is provided with a multiplicity of mirror segments 11. The mirror segments 11 can be arranged in arbitrary number next to one another and in one or more rows behind one another. In the illustrative embodiment according to FIG. 2, three rows of mirror segments 11 with in each case a multiplicity of equal or identical mirror segments are provided merely by way of example. If a number of such holders 10 are arranged on a mirror carrier 9, a total number of several hundred mirror segments 11 can be obtained. As can be seen, in particular, from FIG. 3, a holder 10 has at least approximately a saw blade form, the parts protruding in the manner of teeth being constructed as receptacles 12 for the mirror segments 11.

To provide homogeneous illumination, the rays arriving from the light source 3 must be focussed correspondingly for which purpose the individual mirror segments 11 must be accommodated in each case individually with different tilt angles in the receptacles 12 of the holder 10. For this purpose, the receptacles 12 are correspondingly provided with stops, edges, bevels and the like, not shown in greater detail. The mirror segments 11 are formed in the form of strips which are provided with a reflective surface 13 on one longitudinal side or on the top pointing outward. The individual strips forming the mirror segments 11 are of identical form. As can be seen, in particular, from FIG. 3, the mirror segments 11 are accommodated in a slightly curved form in the receptacles 12. This can be achieved in a simple manner by the fact that the mirror segments consist of an elastically resilient and correspondingly thin material and are clamped under a pretension between in each case two mutually opposite receptacles 12. This results in the curved form.

The aspect ratios of the identically arranged mirror segments, namely the ratio of length and width of the strips can be greater than 1:5, preferably greater than 1:20, depending on application. This means that, for example with a length of a mirror segment 11 of, for example, 50 mm, the width can be between 10 and 2.5 mm and even below that if necessary.

To achieve the highest possible filling ratio of the field facet mirror 1, the individual mirror segments 11 should be arranged on the holders 10 in such a manner that the longitudinal edges of adjacent mirror segments 11 abut one another directly without clearance.

The mirror segments 11 can be connected to the holder in the receptacles 12 by any means such as, for example, non-positively, positively or surface-bonded. Thus, for example, clamping connections or adhesive connections are possible. As a non-positive joining technique, a snap-on connection can be provided, for example, by means of which the correspondingly pretensioned mirror segments 11 correspondingly snap into shoulders, projections, undercuts or the like.

Surface-bonded joining techniques which can be used are, for example, chemical solders, adhesives or metallic connections.

If the mirror segments 11 are inserted with corresponding pretension and curved into the receptacles 12, a tilt angle can already be set in one direction in this manner. The second tilt angle can then be set by a respective arrangement of the receptacles 12. This makes it possible to set tilt angles in two directions or planes for each mirror segment 11.

Due to the mirror segments 11 inserted into the receptacles 12 at different tilt angles, gaps are produced between the individual mirror segments 11. To bridge the gaps, blocking layers, for example in the form of foils 14, can be inserted into the gaps. Suitable foils 14 are, for example, aluminium or gold foils.

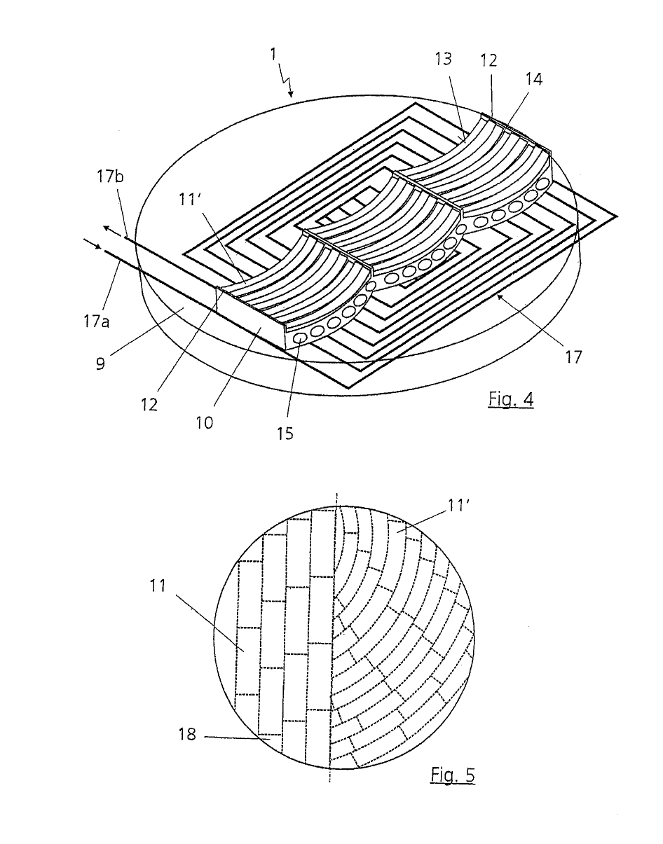

To ensure uniform temperature regulation of the facet mirror 1, the holder 10 can also be provided with coolant ducts, for example in the form of drilled holes 15 which are arranged next to one another in corresponding number and form a coolant circuit by means of a connection to one another (see FIG. 4 with the basic representation).

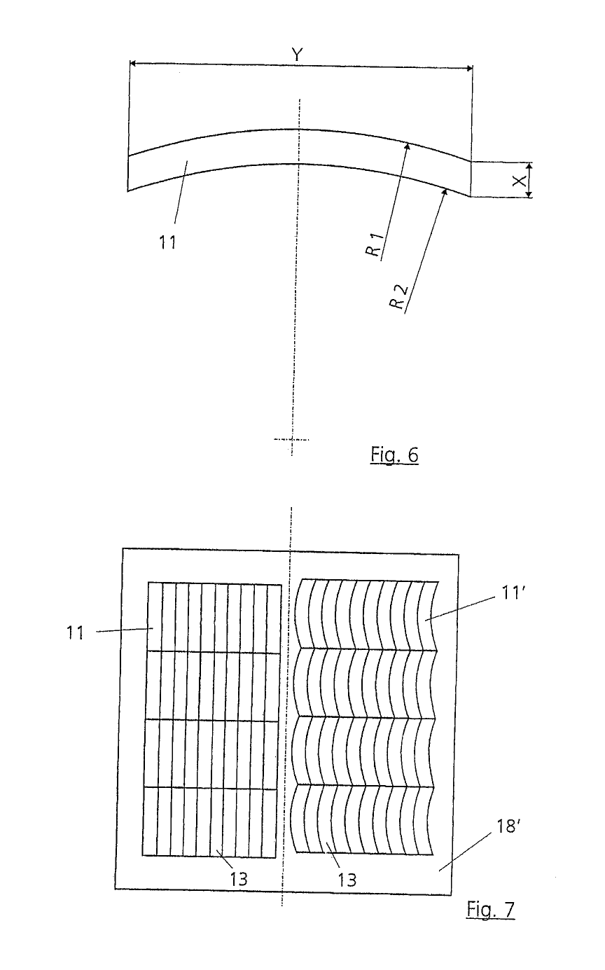

FIG. 4 shows an arrangement of a facet mirror 1 which essentially corresponds to the structure according to FIG. 2. The essential difference is only that, instead of elongated rectangular strips for the individual mirror segments 11, mirror segments 11′ are provided which have a slightly curved form in the manner of a crescent (see FIG. 6). The curved forms of the mirror segments 11 are located in one plane perpendicular to the optical axis 16 and are thus in the X/Y plane, considering the optical axis as the z axis. This embodiment of the mirror segments 11′ allows a mirror to be saved in the illumination system which is normally provided for forming the field in order to form an annular field for the reticule 6 from the bundle of rays. The “crescent curvature” (according to FIG. 6) of the mirror segments 11′ thus additionally provides the desired form of the field without separate mirror.

In the mirror segment 11 shown in FIG. 6, the outside radius R₁ and the inside radius R₂ can be identical, but can also be different. With a length y of the mirror segment 11 of, for example, 50 mm and with a thickness x of, for example, 3 mm, the two radii R₁ and R₂ can be, for example, 65 mm.

In addition to the crescent form of the mirror segments 11′, these can naturally also be curved and inclined in a plane perpendicular thereto as is the case in the mirror segments 11 according to FIG. 2.

FIG. 4 also shows that, for forming a coolant circuit, the drilled holes 15 are connected to one another by means of a coolant feed 17a and a coolant return 17b.

Since such cooling systems and coolant circuits are generally known, they will not be discussed in greater detail at this point.

Additionally or alternatively, coolant ducts can naturally also be arranged in the mirror carrier 9.

FIG. 5 shows a top view of a disc 18 which can be, for example, a wafer disc and consists of silicon. As shown by the dashed lines, the individual mirror segments 11 can be separated out of such a disc 18 in an arbitrary manner, having identical forms.

In FIG. 5, mirror segments 11 are shown, for example, in elongated rectangular strip form on the left-hand half and mirror segments 11′ in curved crescent form 11 are shown on the right-hand half. One side of the disc 18 can already be polished and in this manner form the reflective surfaces 13 of the mirror segments 11 or 11′ with correspondingly high accuracy. Coating of the surfaces is also possible.

As an alternative, the mirror segments 11 or 11′ can also be produced from thin diaphragms, moulded by electrodeposition, as substrate carriers 18′ (see FIG. 7), the surface of the diaphragms having the correspondingly required optical quality for correspondingly forming the reflective surfaces 13.

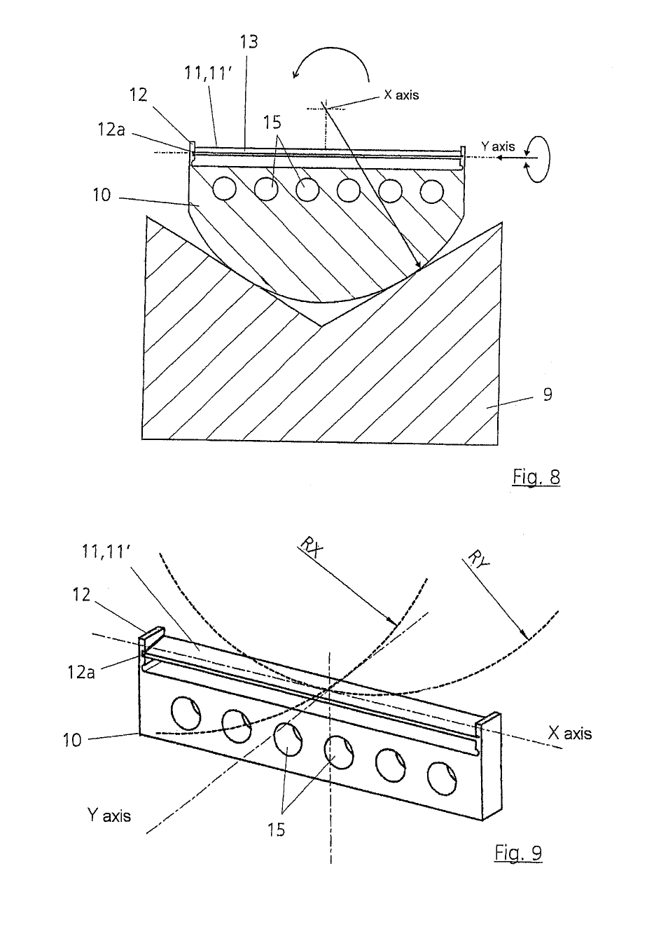

FIG. 8 shows an enlarged representation of the mounting of a holder 10 in a mirror carrier 9 by means of the arrangement of which first and second tilt angles can be set for a mirror segment 11. As can be seen, the holder is spherical on its side associated with the mirror carrier 9, for example formed in the form of a semicylinder, the holder 10 being supported in this form in a wedge-shaped support 19 of the mirror carrier 9. This results in a tilting radius or tilt angle Rₓ with a centre point about the X axis for the holder 10.

The second tilt angle or angle of inclination R_{y} about the Y axis is set by the embodiment of a receiving member 12a in the receptacle 12. As can be seen, the receiving member 12a is arranged as longitudinal slot. The longitudinal axis of the longitudinal slot 12a extends in the direction of the second tilt angle, namely of the tilt angle R_{y} (see also FIG. 9). The X axis extends perpendicularly to the plane of the drawing in FIG. 8.

The tilt angles Rₓ and R_{y} can also be seen in the perspective representation in FIG. 9.

The mirror segments according to the illustrative embodiment according to FIGS. 8 and 9 are arranged to be spherical, the spherical formation being equally large in both directions, namely the X axis and the Y axis. Naturally, however, this is not absolutely necessary. The spherical formation with the tilt angle R_{y} or tilt radius is obtained from the fact that the mirror segments 11 are inserted into the receiving members 12a and are pretensioned. This means that the length y of the mirror segments is greater than the distance of the oppositely located receiving members 12a which is why, when the mirror segments 11 are inserted into the longitudinal slots as receiving members 12a, the mirror segments are correspondingly bent due to their elasticity. The degree of bending depends on the differences in length between the length of the respective mirror segment and the distance of the oppositely located receiving members 12a. Instead of a spherical formation of the mirror segments or reflective surfaces 13 of the mirror segments 11, 11′, aspherical areas or also any other forms of area and curvatures can also be provided for this purpose.

This also sets the refractive power of the mirror segments due to the installed state of the mirror segments 11 and 11′, for example according to the illustrative embodiment according to FIGS. 8 and 9.

1. Facet mirror comprising a multiplicity of mirror segments which are provided with reflective surfaces, a number of mirror segments in each case being arranged on a mirror carrier, at least a part of the mirror segments having an aspect ratio of greater than 1:5, being identically arranged and individually accommodated in a holder, and a number of mirror elements being accommodated behind one another and in a number of rows next to one another in said holder.

2. Facet mirror according to claim 1, wherein the aspect ratio is greater than 1:20.

3. Facet mirror according to claim 1, wherein the holders are in each case mounted on the mirror carrier.

4. Facet mirror according to claim 1, wherein at least some of the longitudinal edges of adjacently located mirror segments abut one another.

5. Facet mirror according to claim 1, wherein at least a part of the mirror segments is mounted with different tilt angles on the mirror carrier.

6. Facet mirror according to claim 5, wherein different tilt angles in two planes are provided.

7. Facet mirror according to claim 1, wherein the mirror segments are in each case formed from strips which are in each case provided with the reflective surfaces on one longitudinal side.

8. Facet mirror according to claim 7, wherein the strips are separated out of a disc or plate or a foil-like substrate carrier.

9. Facet mirror according to claim 8, wherein the disc or plate is a silicon body.

10. Facet mirror according to claim 7, wherein the strips are formed from a wafer disc.

11. Facet mirror according to claim 7, wherein the mirror segments formed from strips have at least approximately a crescent form.

12. Facet mirror according to claim 1, wherein the mirror segments are accommodated in receptacles of the holder with predetermined tilt angles.

13. Facet mirror according to claim 12, wherein the predetermined tilt angles are moulded into the receptacles.

14. Facet mirror according to claim 1, wherein the mirror segments are arranged to be elastically resilient.

15. Facet mirror according to claim 12, wherein the mirror segments are inserted into the receptacles of the holder at a predetermined first tilt angle (Rₓ), wherein a second tilt angle (R_{y}) is in each case set by the arrangement of a receiving member in the receptacle.

16. Facet mirror according to claim 15, wherein the receiving member is arranged as longitudinal slot in the receptacle.

17. Facet mirror according to claim 16, wherein the longitudinal axis of the longitudinal slot extends in the direction of the second tilt angle (R_{y}).

18. Facet mirror according to claim 12, wherein the mirror segments are inserted into the receptacles and are pretensioned, forming a curved surface.

19. Facet mirror according to claim 12, wherein the refractive power of the mirror segments is defined by the installed state of the mirror segments.

20. Facet mirror according to claim 1, wherein the reflective surfaces of the mirror segments are arranged to be spherical.

21. Facet mirror according to claim 20, wherein the spherical formation is at least approximately equally large in both directions (X, Y).

22. Facet mirror according to claim 1, wherein the mirror elements are arranged to be aspherical.

23. Facet mirror according to claim 12, wherein the mirror segments are accommodated non-positively in the receptacles.

24. Facet mirror according to claim 12, wherein the mirror segments are accommodated positively in the receptacles.

25. Facet mirror according to claim 12, wherein the mirror segments are accommodated in surface-bonded manner in the receptacles.

26. Facet mirror according to claim 1, wherein the holder has at least approximately a saw blade form, the protruding parts of which are arranged as receptacles for the mirror segments.

27. Facet mirror according to claim 1, wherein the mirror segments are formed from diaphragms moulded by electrodeposition as substrate carriers, one side being provided with the reflective surface in optical quality.

28. Facet mirror according to claim 1, wherein between the individual mirror segments, blocking layers are provided at least for a part of the mirror segments for bridging a gap in the case of different tilt angles.

29. Facet mirror according to claim 28, wherein the blocking layers are arranged as foils.

30. Facet mirror according to claim 1, wherein coolant ducts are arranged in the holder.

31. Facet mirror according to claim 30, wherein the holder is provided with coolant ducts in the form of drilled holes, the drilled holes being connected to one another to form a coolant circuit.

32. Facet mirror for a lithographic projection exposure system comprising a multiplicity of mirror segments which are provided with reflective surfaces, a number of mirror segments in each case being arranged on a mirror carrier, at least a part of the mirror segments having an aspect ratio of greater than 1:5, being arranged to be identical and being accommodated individually in a common holder.

33. Facet mirror comprising a multiplicity of mirror segments which are provided with reflective surfaces, a number of mirror segments in each case being arranged on a mirror carrier, at least a part of the mirror segments having an aspect ratio of greater than 1:5, being arranged to be identical and accommodated individually in a holder, wherein in each case a number of mirror elements are accommodated next to one another in the holder, at least some of the longitudinal edges of adjacently located mirror segments abutting one another.

34. Projection exposure system for EUV lithography comprising an illumination system and a projection lens, wherein at least one facet mirror according to claim 1 is arranged in the projection exposure system.

35. Projection exposure system according to claim 34, wherein at least one facet mirror is arranged in the illumination system.

36. Projection exposure system according to claim 35, wherein the at least one facet mirror is constructed as field facet mirror.
